(19) United States
(12) Patent Application Publication
(10) Pub. No.: US 2007/0084922 A1
(43) Pub. Date: Apr. 19, 2007

(54) Card receptacle and method

(75) Inventors: Dieter Klostermeier, Villingen-Schwenningen (DE); Thomas Riester, Villingen-Schwenningen (DE); Torsten Wahler, Bad Duerrheim (DE); Peter Wolf, Niedereschach (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/555,419

(22) PCT Filed: Apr. 22, 2004
(86) PCT No.: PCT/EP04/04293

§ 371 Date: Dec. 20, 2006

(30) Foreign Application Priority Data
May 12, 2003 (DE) 103 21 251.5

(51) Int. Cl. G06K 7/06

(52) U.S. Cl. 235/441

(57) ABSTRACT

A card receptacle and a method for receiving a card in a receptacle of this type are disclosed. The receptacle and method may be used in a tacograph with a planar construction in a motor vehicle. The receptacle includes a receiving opening for receiving a card that contains a data memory, a closure for closing the receiving opening and a locking unit including at least one locking element that can be displaced into a locked position, in which the locking element secures the closure. Complex technical difficulties arising from the need for a fully-automatic card insertion necessitate a requirement for a robust, space-saving, manipulation-proof mechanical and electronic system that can be operated without incurring damage. The invention provides a device and a method, in which the card receptacle has at least one first sensor and the position of the locking element can be captured by said first sensor

The invention relates to a card receiving device, in particular for a tachograph in a motor vehicle of a flat construction, with a receiving opening for receiving a card, which has a memory for data, with a closure for closing the receiving opening, with a locking unit, which has at least one locking element, which can be moved into a locked position in which the locking element locks the closure. In addition, a method for receiving a card by means of a card receiving device in which the card is inserted into the card receiving device during an insertion phase is also the subject of the invention.

The main focus of application of the device according to the invention and the method according to the invention lies in the area of tachographs or devices for recording the working periods and rest periods of commercial vehicle drivers. However, other applications are likewise feasible, for example in the area of banking and for making payments, or locking systems. The invention is advantageously used in combination with all types of card-like data storage media. On account of the great commercial and legal importance of the data which can be acquired with tachographs, the recordings have to be reliably secured against manipulation. The security measures relate both to data acquisition and data transmission and to the transmission and storage of the acquired data in the memory of the card. Relevant standards place strict requirements on the security standard to be achieved by the measures. It is therefore stipulated that the card should be entirely held by the card receiving device during the reading and writing operations and be isolated from the surroundings by means of suitable closure devices. The closure devices have to be locked in the closed position during the reading and writing operations. Additional difficulties arise on account of operational failures in conventional devices caused by contamination, in particular by contact being interrupted or even when the card is being drawn in. It is problematical to draw in the card and position it exactly on the contacts of the device because the cards have high manufacturing tolerances in relation to the required positional accuracy with respect to the contacts of the device. Since the cards are predominantly perceived by the user to be distinguished by a high degree of robustness, said cards are generally not handled with the care that is actually required, so that, in addition to the tolerances caused by manufacture, deformation and damage impair the way in which the card operates when interacting with the card receiving devices. Furthermore, the operating conditions in motor vehicles place increased requirements on functional reliability on account of the pronounced vibrations and countless bumps and the wide-ranging temperature fluctuations. Implementing security against manipulation and the desired handling convenience mean it is necessary to draw in the card fully automatically. However, in order to meet this requirement, great difficulties are faced in terms of construction because the installation space available in a tachograph, which is the size of a car radio, provides only approximately a height of 10 mm for the fully automatic drawing-in process.

Great technical difficulties arising from the need for a fully automatic card insertion necessitate a requirement for a robust, space-saving, manipulation-proof mechanical and electronic system that can be operated without incurring damage. The requirement for robustness is especially put to the test when the device is improperly operated. In addition, allowance must be made for the often inadequate precision of human dexterity when operating the device in relation to the acquired accuracy of the precision engineering of the device by taking correspondingly compensatory precautions.

DE 101 53 995 already discloses a chip-card receiving device of the generic type with locking means. However, it has been found that, in the case of the proposed embodiment, insufficient allowance is made for the previously mentioned problems, since there has been in particular a high incidence of damage to the device caused by misplaced positioning of the card to be received.

On the basis of the problems caused by disadvantages of the prior art, it is the object of the invention to provide a card receiving device and a method for receiving a card in a corresponding device that are not affected by the great mechanical loads during operation, in particular during improper handling.

To achieve the object, the invention proposes a card receiving device mentioned at the beginning which has at least one first sensor, by means of which the position of the locking element can be sensed. Also proposed is a method mentioned at the beginning in which, after the insertion phase of the card, a locking unit moves into a locked position, in which a closure of a receiving opening for the card is locked by means of the locking unit, a sensor senses the locked position of the locking unit and signals it to the central control system.

With the sensory monitoring of the locking unit, the invention has recognized the key role of the locking in the matter of receiving the card. This recognition is based on the experience that many instances of damage, in particular in the form of jamming of the card to be received in the device, are attributable to incorrect positioning in relation to the locking elements of the locking unit. Since the entire device is operated in a relatively confined space, the leeway available between the card transported into the interior of the device, the closure and the locking unit is relatively small, so that even minor positioning errors can lead to blockages of the device with serious implications. Consequently, on account of the key function of the mechanical components to be monitored, the sensory monitoring has special advantages.

An advantageous development of the card receiving device according to the invention provides that the card receiving device has a central control system, which is in connection with the first sensor. The central control system can advantageously inquire the status of the locking unit permanently or situation-dependently and make allowance for this information in the functionally appropriate control of all the elements to be activated, such as drives or display units for example.

Increased immunity to malfunctions is obtained if the card receiving device has at least one second sensor, the second sensor senses at. least one phase of the reception of the card and, at the beginning and/or end of the phase, sends at least one signal to the central control system.

Security against manipulation is additionally increased if the card receiving device has an arresting unit, which can be moved into an arrested position and, in the arrested position, arrests the locking unit located in the locked position.

In order that the locking unit and the arresting unit are not damaged, it is expedient if the second sensor senses the beginning or the end of the arrestment of the locking unit in the locked position of the card and sends at least one signal to the central control system at the beginning and/or the end of the arrestment of the locking unit. In this way, the central control system advantageously receives information on the status of the arresting unit and, dependent on this, can control the initiation of further steps for receiving the card or for data transmission. At the same time, by means of the sensor system, possibly in combination with the first sensor, the proper locking and arrestment of the closure can be monitored, so that no manipulation can take place unnoticed during data transmissions between the card and the device. The central control system expediently only initiates a data transmission operation to the card being received, or maintains it, only if the first sensor signals that the locking unit is in the locked position and the second sensor signals that the arresting unit is in the arrested position.

Instead of direct monitoring or in addition to a directly monitoring sensor, it may on the one hand be less costly and on the other hand be functionally more appropriate if the card receiving device has at least one movable gear element, which is formed and coupled into the kinetic mechanism of the card receiving device in such a way that each position of this gear element during the transport of the card into an end position can be uniquely assigned a movement phase of the drawing-in, locking and/or arrestment of the locking. If the gear mechanism has such a gear element, there is the possibility that, for example, the second sensor or a further sensor is coupled to the gear element in a sensory manner, at least one position of the gear element can be sensed by means of the sensor and in this way the beginning and/or the end of the movement phase can be sensed by means of the kinetic assignment. Conceivable here in particular as movement phases are the points in time at the beginning and end of the closing, locking or arresting or else a clamping or gripping and transporting of the card to be received, possibly also a fine positioning of the card.

Depending on the installation situation and intended use, the individual sensors are advantageously optical, inductive, capacitive and/or mechanical in their operating mode. The functioning is often achieved by an optical sensor for the sensing of the position of the movable components, in particular with forked light barriers, which interact with lugs attached to the components to be monitored.

Reliable security against manipulation can often be achieved if the card can be drawn completely into the interior of the card receiving device. Additional security against attempted manipulations is obtained if the locking element not only locks a closure closing the receiving opening in a locked position but also at least partially blocks the clear cross section of the receiving opening in the locked position. Even if the closure closing the receiving opening happens to be damaged, access to the card located in the card receiving device is still prevented because of the locking element.

In order that the high security requirements are met even during the data transmission between the memory of the card and the card receiving device for the tachograph, it is expedient if the position of the locking element in the locked position can be permanently inquired by means of the first sensor and the first sensor permanently signals the sensed position to the central control system by means of signals transmitted to the central control system. In this way, loss of the locked position during a data transmission can also be stored in the memory of the card, whereby attempted manipulations are correspondingly demonstrable.

In order to reduce further the susceptibility to faults of the device according to the invention, it is expedient if the card receiving device has a third sensor, which senses the presence in the device of the card to be received. In this way, a manipulative or inadvertently initiated drawing-in operation without the card can be terminated after detection of the absence of the card, and the system can be reset to the original state. It is advisable in this respect if the third sensor is formed in such a way that it can be actuated by the card to be received itself or by a card receiving unit that is movable in the inward direction. A mechanical operating mode is particularly advantageous here, since sensors of this type generally do not require auxiliary power and are therefore energy-saving and particularly fail-safe devices. The independence of the sensors from a power supply also gives rise to the further advantage that the power supply to the card receiving device or individual modules of this device can be switched on by means of such a sensor. An advantageous development of the invention provides that a third sensor is formed in such a way that it can be actuated in response to actuation of opened switches, or normally closed contacts and by a card receiving unit that moves with the card in the inward direction, so that, if there is no card in the card receiving device, it is actuated and the switch is open, if there is a drawing-in movement of the card receiving device, it is no longer actuated and the switch changes into a closed position. Being formed in this way provides the special advantage that no slotted link has to be provided for the actuation of the third sensor, bringing the sensor of the switch into the closed position in dependence on the movement phase of the card, but instead the inactive position in the absence of a card is used for the actuation of the switch or for the interruption of a power circuit.

In order to sense the readiness for data transmission between the card and the tachograph in an end position of the card, it is expedient if the card receiving device has a fourth sensor, by means of which it can be sensed whether the card has reached the end position in the card receiving device. On account of the relatively narrow dimensional tolerances of the contacts arranged on the standardized card, it is advisable if the fourth sensor is integrally formed with a set of contacts provided for the contacting of the card. Here, too, the use of a switch provided with mechanical elements is suitable. The advantages of the invention come fully to bear if the card can be automatically drawn in and/or withdrawn.

An advantageous development of the method according to the invention provides that, during the insertion phase, the card inserted into the card receiving device is sensed by means of the third sensor, the insertion is signaled to a central control system and the central control system switches on the power supply to a drive. Apart from the drive, further electrical components, in particular with intensive power consumption, that have been disconnected from the power supply can also be switched on by the central control system, for example display lighting systems. This helps to conserve the available energy resources.

The device according to the invention and the associated method according to the invention are particularly space-saving if, after the insertion phase, a clamping unit clamps the card during a gripping phase and the card is transported into the receiving device during a transporting phase. By contrast with transport by means of rubber rollers, the use of a clamping unit has the advantage that the clamping unit permits a particularly flat construction, whereas the function of a drive by means of rollers requires a certain minimum diameter of the individual rollers and, dependent on the length of the transporting distance, a certain number of rollers. To ensure a high degree of functionality and security, it is expedient if, after the insertion phase, transporting phase and/or gripping phase, the clamping of the clamping unit is released from the card during a prepositioning phase and the second sensor senses the end of the prepositioning phase and signals it to the central control system. Only once the clamping unit is released is it possible to correct the manual inaccuracies of insertion of the card into the clamping unit, and the signal of the second sensor provides the central control system with information feedback on how the receiving operation is proceeding.

For correction of the inaccurate manual insertion of the card to be received into the card receiving device, an advantageous development of the method according to the invention provides that, after the insertion phase, transporting phase, gripping phase and/or prepositioning phase, the locking unit moves into the locked position in a fine positioning phase and the card is thereby transported into the end position, in which first contacts of a set of contacts are in connection with second contacts of the card. Dividing the transport of the card into an insertion phase, in which the card is initially transported into the interior of the card receiving device, and a fine positioning phase, allows error-free data transmission in spite of the often inaccurate manual insertion of the card and the relatively narrow dimensional tolerances of the contacts on the card. For monitoring the successful fine positioning of the card, it is expedient if the fourth sensor senses the end position of the card and signals it to the central control system.

A refinement of the method according to the invention that conforms entirely to the statutory regulations provides that, after the insertion phase, transporting phase, gripping phase, prepositioning phase and/or fine positioning phase, an arresting unit is moved into the arrested position, in which the locking unit is arrested by means of the arresting unit, in a securing phase. A manipulation attempted on the closure with fraudulent intent is prevented with dual security, since first the locking and then the arrestment have to be overcome.

The security against manipulation and functional reliability are additionally increased if the second sensor senses the arrested position of the arresting unit and signals it to the central control system. Permanent monitoring of the signal makes it possible to demonstrate an unforeseen movement of the arresting unit from the arrested position. At the same time, the central control system can switch off the drive of the card receiving device. To save energy, switching off the drive expediently takes place only when the time period between the signal which signals the end of the prepositioning phase and the signal which signals the reaching of the locked position of the locking device does not exceed a predetermined value, since otherwise the probability of a malfunction is increased. If the time value is exceeded, it is expedient if the central control system initiates an operation for the card to be withdrawn.

A data transmission phase, which follows the insertion phase, transporting phase, gripping phase, prepositioning phase, fine positioning phase and/or securing phase and in which information is transmitted between the memory of the card and the card receiving device or the tachograph, should be interrupted if the second sensor no longer signals the arrested position of the arresting unit or the first sensor no longer signals the locked position or if one of the two sensors indicates leaving of the position to be monitored.

A specific exemplary embodiment of the card receiving device according to the invention and of the method according to the invention is described in more detail below to illustrate the invention, with reference to drawings, in which:

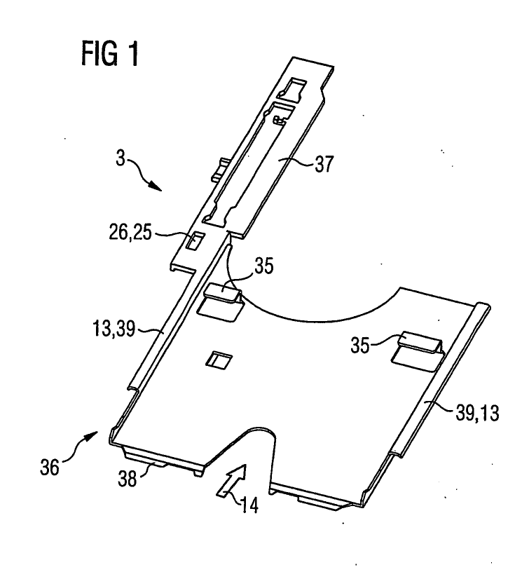

FIG. 1 shows a perspective view of a card receiving unit,

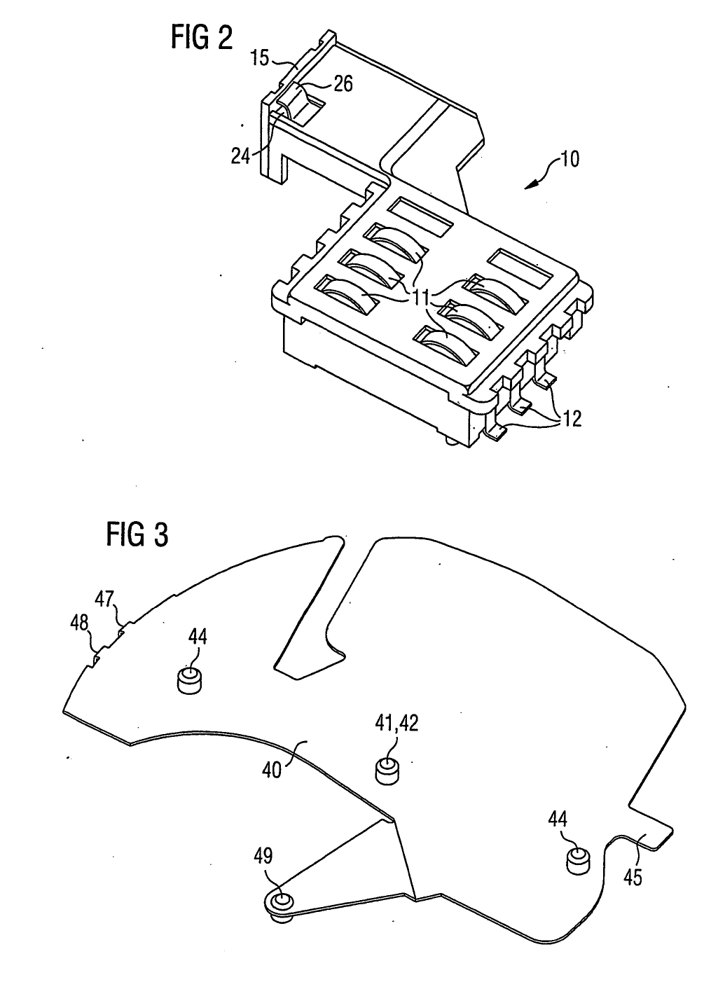

FIG. 2 shows a perspective view of a set of contacts, looking toward the contacts,

FIG. 3 shows a perspective view of a gear element according to the invention,

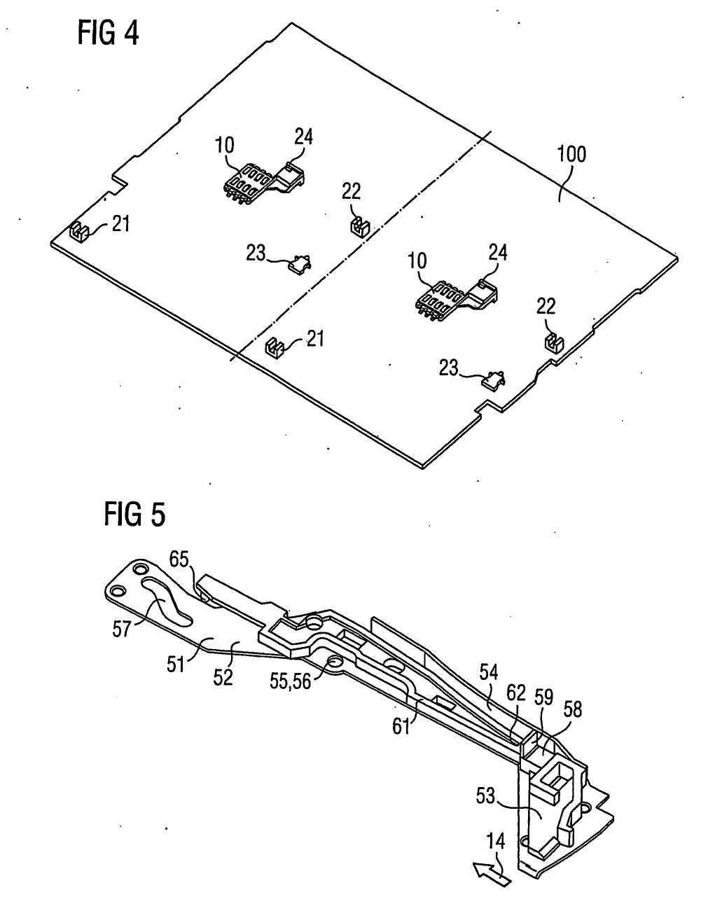

FIG. 4 shows a printed circuit board for a card receiving device according to the invention of a tachograph,

FIG. 5 shows a perspective view of a locking element, which in the case of the card receiving device according to the invention of the exemplary embodiment presented is arranged on the right-hand side,

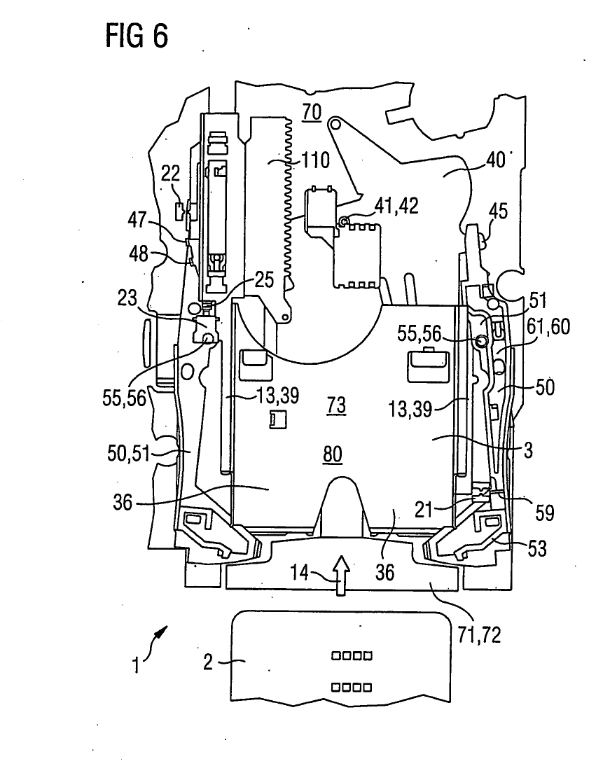

FIGS. 6 to 10 each show a view from below of a card receiving device according to the invention in different phases of the reception of a card,

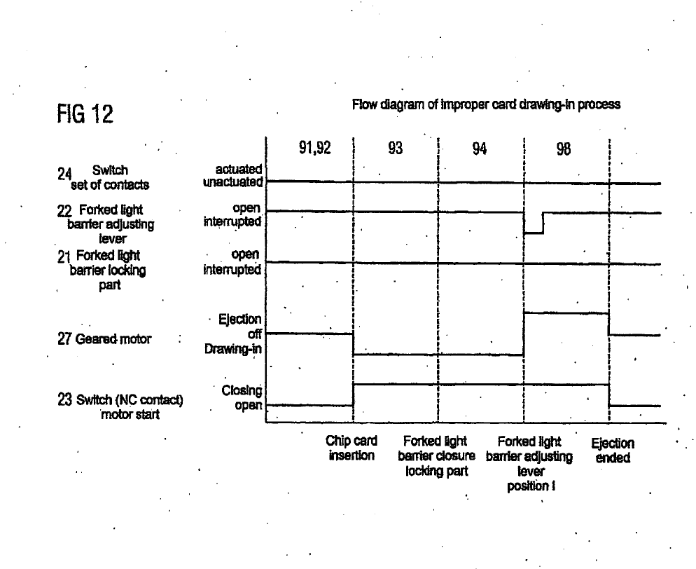

FIGS. 11 and 12 each show a flow diagram of a card drawing-in process by means of a card receiving device according to the invention.

The card receiving device 3, represented in a simplified form in FIG. 1, substantially comprises a slide 36 and an extension arm 37, to which a toothed rack element 110 represented in FIG. 6 is resiliently attached. A first linear mount 13, which is in the form of two sliding bearing surfaces 39 arranged on the side of the slide 36, runs in an inward direction 14, in which the extension arm 37 extends.

The slide 36 interacts with a clamping element (not represented), so that a card 2 to be received (not represented) is clamped in the manner of tongs by the card receiving unit 3. For this purpose, a card 2 (not represented) is pushed over run-in slopes 38 on the input side along the slide 36 as far as two stops 35, so that continued pressure against the inserted card 2 moves the card receiving unit 3 in the inward direction 14. A third sensor 23, formed in FIGS. 6 to 10 as a normally closed contact, is relieved by a projection 25, moving with the card receiving unit 3 in the inward direction 14, so that the third sensor 23, formed as a switch, is no longer actuated and changes into the closed position.

Represented in FIG. 2 is a set of contacts 10, which has as its main components six contacts 11, various terminals 12, a second stop 15 and a fourth sensor 24. The second stop 15 is integrally formed with the set of contacts 10, since great dimensional stability can be achieved in this way between the contacts 11 and the stop edge of the stop 15. The fourth sensor 24 has a mechanical actuating element 26, which makes contact with the card 2 reaching an end position, on an end face leading in the inward direction 14, and signals this operation to a central control system (not represented).

FIG. 3 shows a central gear element 40 in isolation, while in FIGS. 6 to 10 it is represented in various movement phases in interaction with a locking unit 50 and an arresting unit 60. In a central first axis of rotation 41, the gear element 40 is provided with a projection, about which it is rotatably attached to a carrier 70, represented in FIGS. 6 to 10. A first pin 49, attached to an extension arm 43, serves for introducing force by means of a drive (not represented). The gear element 40 transfers the introduced force of the drive by means of an eccentrically arranged second pin 44 to the locking unit 50. By means of a driver 45, arranged on the outer periphery, the gear element 40 transfers the actuating force to the arresting unit 60. The gear element 40 is formed as a punched sheet-metal part and is provided on the outer periphery with two bent-away projections 47, 48, which are formed as signalers for the position of the gear element 40 in interaction with a second sensor 22, which is represented in FIG. 4 and configured as a forked light barrier.

Represented in FIG. 4 is a printed circuit board 100 for two card receiving devices 1 according to the invention that are arranged next to each other, which is to be loaded with components entirely by the SMD technique, so that no flexible leads are required. The main components for each card receiving device 1 are a centrally arranged set of contacts 10, a first sensor 21, which is formed as a forked light barrier for the detection of a locking element 51 of the locking unit 50, a second sensor 22, which is likewise formed as a forked light barrier for the detection of the movement phases of the arresting unit 60 via the gear element 40 as a forked light barrier, and a third sensor 23, which is formed as a switch to be mechanically actuated to register the insertion of a card 2.

Represented in FIG. 5 is a locking element 51 of the locking unit 50 together with an arresting element 61 of the arresting unit 60. The main component parts of the locking element 51 are a base plate 52, a bearing piece 53 attached on the base plate 52 and a leaf spring 54, pressing resiliently against the bearing piece 53. The locking element 51 is mounted on the carrier 70 rotatably about a second axis of rotation 51 in a second mount 56, as represented in FIGS. 6 to 10. These representations likewise show that the longitudinal extent of the locking element 51 is in the inward direction 14. Substantially transversely in relation to the inward direction 14, the bearing piece 53 is mounted in a sliding manner, linearly displaceable on the base plate 52 of the locking element 51. The locking element 51 is located on both sides of a card receiving compartment 80, represented in FIGS. 6 to 10, and the bearing piece 53 is kept under prestress by the leaf spring 54, respectively in the direction of the center of a receiving compartment 80. The base plate 52 is provided with a first slotted link-like guide 57, which respectively interacts with one of the two second pins 44 of the gear element 40. The arresting element 61 is mounted in a sliding manner, linearly in the longitudinal direction of the locking element 51, and is formed in a displaceable manner in relation to the locking element 51. At the end on the input side, the arresting element 61 is provided with a taper 62, which moves in behind the recess 58 (not represented in any more detail) of the bearing piece 53 to arrest the bearing piece 53 in an arrested position, so that the bearing piece 53 is restricted in its freedom of movement in relation to the locking element 51. The bearing piece 53 has a projection 59, which interacts with the first sensor 21, which is formed as a forked light barrier, to sense the locked position. The arresting element 61 has a third pin 65, by means of which, in interaction with the driver 45 of the gear element 40, the arresting element 61 is displaced into the arrested position on the locking element 51.

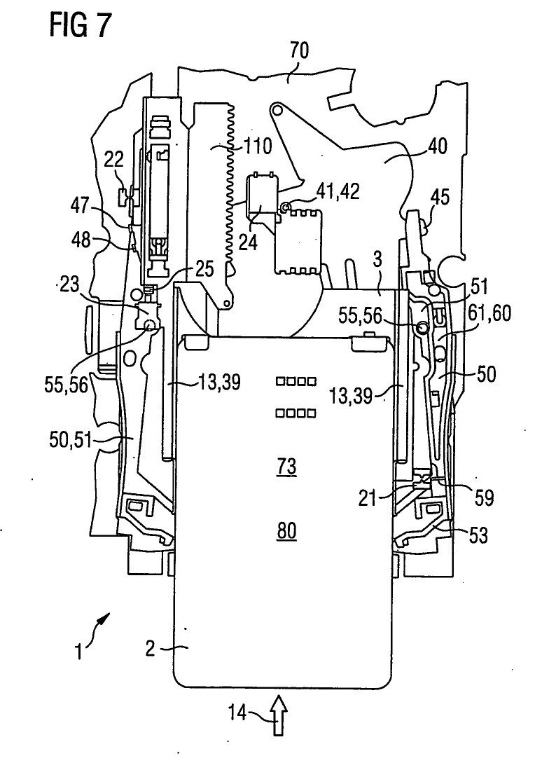

In FIG. 6, a card 2 is in front of a card receiving device 1 according to the invention, which is ready to receive a card 2. The locking elements 51 are completely open and the closure 72, attached to a second leaf spring 71 integrally formed with the carrier 70, is freely movable transversely in relation to a pushing-in plane 73 of the card 2, unhindered by the locking elements 51. During the snapshot, represented in FIG. 7, of a transporting phase of the card 2 into the card receiving device 1, the third sensor 23 has already been relieved by the projection 25, and the power supply to a drive (not represented) of the device has been switched on. The card 2 is fixed on the card receiving unit 3 by means of a clamping unit (not represented in any more detail) of the card receiving unit 3, while the latter is transported into the card receiving device 1 along the sliding bearing surfaces 39 of the first mount 13.

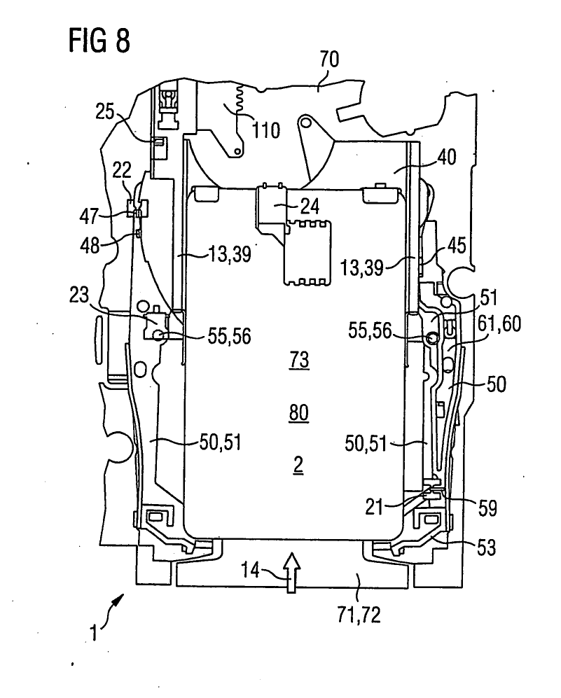

Before the fine positioning phase, represented in FIG. 8, the clamping unit (not represented in any more detail) of the card receiving unit 3 was released, so that the card 2 now rests immovably on the slide 36. In the same action, the locking elements 51 are moved toward each other by means of their first guides 57, by the gear element 40 rotating about the first axis of rotation 41 in interaction with the second pin 44, mirror-symmetrically in the direction of the center of the receiving compartment 80 in the course of a rotational movement about the second axis of rotation 55, so that the clear width of a receiving opening (not represented in any more detail) of the card receiving device 1 is reduced to less than the dimensions at the end of the card 2. At the same time, the first sensor 21, formed as a forked light barrier, senses the engagement of the locking elements 51 by means of the projection 59 and, once locking or fine positioning of the card 2 has taken place, signals the successful completion of this phase to the central control system (not represented). Reaching the end position has the effect of actuating the fourth sensor 24 on the set of contacts 10, which signals to the central control system the readiness for data transmission.

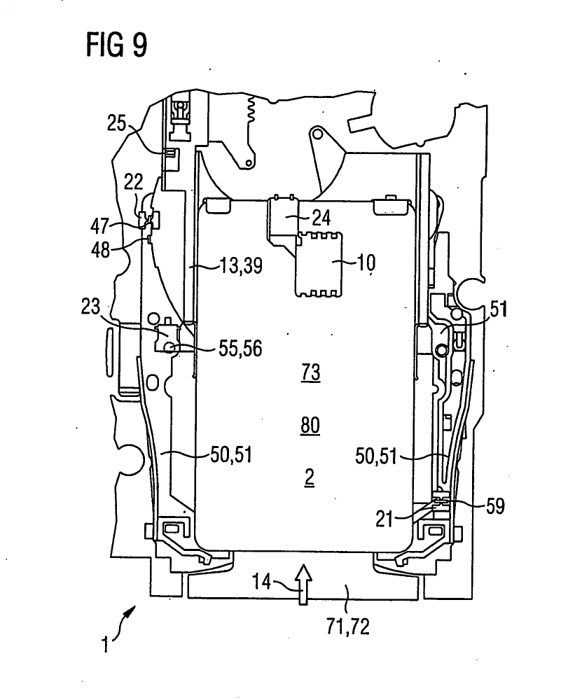

During the securing phase, represented in FIG. 9, the central gear element 40, by means of the driver 45 in interaction with the third pin 65, pushes the arresting element 61 of the arresting unit 60 into the arrested position, in which the arrested bearing piece 53 is restricted in its freedom of movement transversely in relation to the inward direction 14. The beginning of the securing phase is signaled to the central control system by means of the second sensor 22, which is formed as a forked light barrier and senses the first projection 47 of the gear element 40.

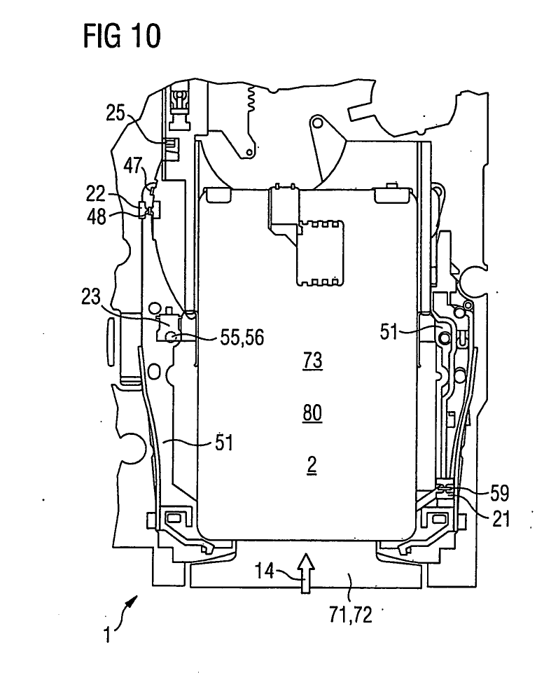

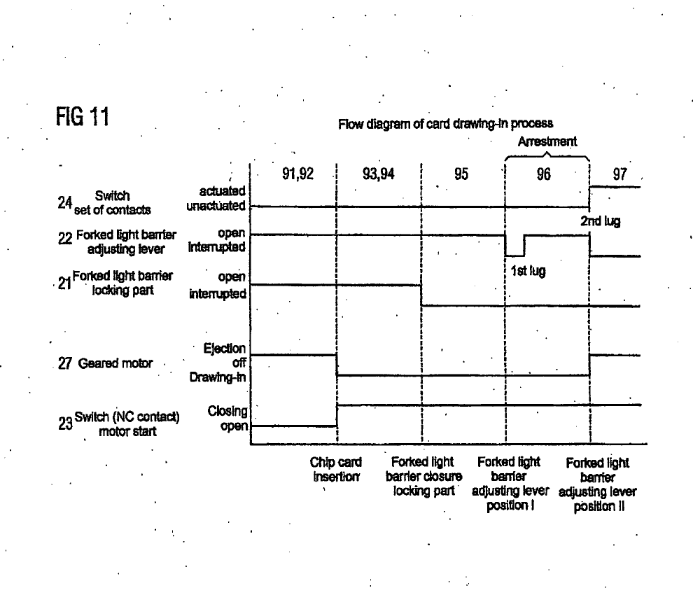

During the further course of the securing phase, represented in FIGS. 9 and 10, the arresting element 61 is displaced into the arrested position along the locking element 51, and toward the end of the securing phase the second sensor 22 senses the second projection 48 of the gear element 40 and signals the end of the securing phase to the central control system. Then, the central control system switches off the power supply to the drive (not represented) and an information exchange between the memory of the card 2 and the tachograph takes place during the subsequent data transmission phase.

In the flow diagram represented in FIG. 12, the signals of the first to fourth sensors 21, 22, 23, 24 during a normally proceeding card drawing-in process and the power supply to the drive 27 in dependence on the phase of the reception of the card 2 are represented. During the insertion phase 91, the gripping phase 92, the card is manually pushed into the card receiving device 1 by the user and grasped by means of a clamping unit (not represented) of the card receiving unit 3. The movement of the card receiving unit 3 in the inward direction 14 brings about switching on of the power supply to the drive 27 by means of the third sensor 23 and, during the subsequent transporting phase 93, the clamped card 2 moves with the card receiving unit 3 in the inward direction 14. During the subsequent prepositioning phase 94, the clamping of the clamping unit (not represented), and consequently the fixing of the card 2 on the card receiving unit 3, are released, so that the card 2 is movable in relation to the slide 36. During the subsequent fine positioning phase 95, the locking elements 51 of the locking unit 50 move into a locked position, in which the closure 72 of the card receiving device 1 is locked. At the same time, the card 2 is transported by means of the bearing pieces 53 into an end position suitable for the data transmission, in which first contacts 11 of the set of contacts 10 are in connection with second contacts of the card 2. The first sensor 21 senses the locked position of the locking unit and sends this signal to the central control system, or the central control system registers the interruption of the forked light barrier of the first sensor 21.

During a subsequent securing phase 96, an arresting element 61 of an arresting unit 60 moves into an arrested position, in which the locking unit 50 is arrested, at the beginning of which the second sensor 22 senses the passing by of the first projection 47 of the gear element 40 and signals it to the central control system. The signal caused at the second sensor 22 as the securing phase 96 proceeds further, on account of the passing by of the second projection 48, indicates to the central control system the end of the securing phase 96, and the drive 27 is switched off.

If the time period between the two successive signals of the second sensor 22 exceeds a certain value, the case represented in FIG. 12 of a card improperly drawn in occurs, and the central control system initiates the ejection 98 of the card 2.

If it proceeds without any errors, the securing phase 96 is followed by a data transmission phase 97, during which information is transmitted between the memory of the card 2 and the card receiving device 1. During the entire data transmission, the arrested position is monitored by means of the second sensor 22 and the locked position is monitored by means of the first sensor 21.

1. A card receiving device for a tachograph in a motor vehicle, the device having a flat construction and comprising:
a receiving opening arranged to receive the card, the card comprising a memory for data,
a closure arranged to close the receiving opening,
a locking unit comprising at least one locking element and arranged to be moved into a locked position in which the locking element locks the closure,
at least one first sensor arranged to sense the position of the locking element and,
an arresting unit arranged to be moved into an arrested position and, in the arrested position, to arrest the locking unit in the locked position.

2. The card receiving device according to claim 1, wherein the card receiving device comprises a central control system arranged in connection with the fist sensor.

3. The card receiving device according to claim 1, wherein the card receiving device comprises at least one second sensor arranged to detect at least one phase of the reception of the card and, at the beginning and/or end of the phase, send at least one signal to the central control system.

4. (canceled)

5. The card receiving device according to claim 3, wherein the second sensor is arranged to detect a beginning or an end of the arrestment of the locking unit in the locked position of the card and send at least one signal to the central control system at the beginning and/or the end of the arrestment of the locking unit.

6. The card receiving device according to claim 5, wherein the central control system farther comprises means to initiate a data transmission operation to the card to be received, or maintains it, only if the first sensor signals that the locking unit is in the locked position and the second sensor signals that the arresting unit is in the arrested position.

7. The card receiving device according to claim 1, wherein the reception of the card comprises the drawing-in of the card, the locking of a closure by means of the locking unit and the arrestment of the locking unit by means of an arresting unit.

8. The card receiving device according to claim 1, wherein the card receiving device comprises at least one movable gear element formed and coupled into the kinetic mechanism of the card receiving device such that each position of the gear element during the transport of the card into an end position is uniquely assigned a movement phase of the drawing-in, locking and/or arrestment of the locking.

9. The card receiving device according to claim 8, wherein:
the second sensor is coupled to the gear element in a sensory manner,
at least one position of the gear element can be sensed by means of the sensor, and
the beginning and/or the end of the movement phase can be sensed by means of the kinetic assignment.

10. The card receiving device according to claim 1, wherein the position can be sensed by means of the first sensor and/or the second sensor optically and/or inductively and/or capacitively and/or mechanically.

11. The card receiving device according to claim 1, wherein the card can be drawn completely into the interior of the card receiving device.

12. The card receiving device according to claim 1, wherein the locking element is arranged to at least partially block the clear cross section of the receiving opening in the locked position.

13. The card receiving device according to claim 1, wherein the position of the locking element in the locked position can be permanently inquired by means of the first sensor and the first sensor permanently signals the sensed position to the central control system by means of signals transmitted to the central control system.

14. The card receiving device according to claim 1, wherein the card receiving device comprises a third sensor comprising means for sensing the presence in the device of the card to be received.

15. The card receiving device according to claim 14, wherein the third sensor further comprises actuating means arranged to be actuated by the card to be received or by a card receiving unit that is movable in the inward direction.

16. The card receiving device according to claim 15, wherein the actuating means is arranged to be actuated mechanically.

17. The card receiving device according to claim 15, wherein actuation of the third sensor has the effect that the power supply to the card receiving device is switched on.

18. The card receiving device according to claim 14, wherein the third sensor comprises a normally closed contact such that it can be actuated by a card receiving unit that moves with the card in the inward direction, so that, if there is no card in the card receiving device, it is actuated and a switch is open, if there is a drawing-in movement of the card receiving device, it is no longer actuated and the switch changes into a closed position.

19. The card receiving device according to claim 1, wherein some modules of the card receiving device are arranged to be disconnected from the power supply and are disconnected from the power supply after not being in use for a certain time.

20. The card receiving device according to claim 1, wherein the card receiving device further comprises a fourth sensor arranged to detect whether the card has reached the end position in the card receiving device.

21. The card receiving device according to claim 1, wherein the card is arranged to be automatically drawn in and/or withdrawn.

22. A method for receiving a card by means of a card receiving device comprising the steps of:
during an insertion phase, the card is inserted into the card receiving device,
after the insertion phase, a locking unit moves into a locked position, in which a closure of a receiving opening for the card is locked by means of the locking unit, a first sensor senses the locked position of the locking unit and signals it to a central control system, and
during a securing phase, an arresting unit moves into an arrested position, in which the locking unit is arrested by means of the arresting unit.

23. The method according to claim 22, wherein:
during the insertion phase, the card is inserted into the card receiving device,
the first sensor senses the locked position of the locking element and signals it to a central control system,
a third sensor senses the insertion of the card and signals the insertion to the central control system, and
the central control system switches on the power supply to a drive.

24. The method according to claim 22, wherein
after the insertion phase, a clamping unit clamps the card during a gripping phase, and
the card is transported into the card receiving device during a transporting phase.

25. The method according to claim 22, wherein
after the insertion phase, transporting phase and/or gripping phase, the clamping of the clamping unit is released from the card during a prepositioning phase, and
a second sensor senses the end of the prepositioning phase and signals it to the central control system.

26. The method according to claim 22, wherein
after the insertion phase, transporting phase, gripping phase and/or propositioning phase, the locking unit moves into a locked position in a fine positioning phase, in which position a closure of a receiving opening for the card is locked by means of the locking unit by means of the locking unit by means of the locking unit by means of the locking unit by means of the locking unit, the card is thereby transported into an end position, in which first contacts of a set of contacts are in connection with second contacts of the card,
a first sensor senses the locked position of the locking unit and signals it to the central control system, and
a fourth sensor senses the end position of the card and signals it to the central control system.

27. The method according to claim 22, wherein
after the insertion phase, transporting phase, gripping phase, prepositioning phase and/or fine positioning phase, the arresting unit is moved into the arrested position during the securing phase, in which position the locking unit is arrested by means of the arresting unit,
the second sensor senses the arrested position of the arresting unit, signals it to the central control system,
and the central control system switches off the drive,
if the time period between the signal which signals the end of the propositioning phase and the signal which signals the reaching of the locked position of the locking unit does not exceed a certain value, otherwise the central control system initiates an operation for the card to be withdrawn.

28. The method according to claim 22, wherein
after the insertion phase, transporting phase, gripping phase, propositioning phase, fine positioning phase and/or securing phase, information is transmitted between the memory of the card and the card receiving device during a data transmission phase if the second sensor signals the arrested position of the arresting unit and the first sensor signals the locked position.

29. A method according to claim 22, wherein
during an insertion phase, the card is inserted into the card receiving device,
a third sensor senses the insertion of the card, signals the insertion to a central control system and the central control system switches on the power supply to a drive,
during a gripping phase, a clamping unit clamps the card,
during a transporting phase, the card is transported into the card receiving device,
during a prepositioning phase, the clamping of the clamping unit is released from the card,
during a fine positioning phase, at least one locking element of a locking unit moves into a locked position, in which a closure of a receiving opening for the card is locked by means of the locking unit,
the card is thereby transported into an end position,
a first sensor senses the locked position of the at least one locking element and signals it to the central control system,
a fourth sensor senses the end position of the card and signals it to the central control system,
during a securing phase, an arresting unit is moved into an arrested position, in which the locking unit is arrested by means of the arresting unit,
the second sensor senses the arrested position of the arresting unit, signals it to the central control system and
the central control system switches off the drive, if the time period between the signal which signals the end of the propositioning phase and the signal which signals the reaching of the locked position of the locking unit does not exceed a certain value, otherwise the central control system initiates an operation for the card to be withdrawn, and
during a data transmission phase, information is transmitted between the memory of the card and the data receiving device if the second sensor signals the arrested position of the arresting unit and the first sensor signals the locked position.
